(19) United States
(12) Patent Application Publication
(10) Pub. No.: US 2008/0185884 A1
(43) Pub. Date: Aug. 7, 2008

(54) SAFETY SEAT HAVING AN ADDITIONAL, ADJUSTABLE BACKREST

(76) Inventor: Holger Hansen, Hamburg (DE)

Correspondence Address: ROBERT W. BECKER & ASSOCIATES, 707 HIGHWAY 333, SUITE B, TIJERAS, NM, 87059-7507, US

(21) Appl. No.: 12/027,423

(22) Filed: Feb. 7, 2008

(30) Foreign Application Priority Data
Feb. 7, 2007 (DE) 10 2007 006 013.2

(51) Int. Cl. B60N 2/42

(52) U.S. Cl. 297/216.13

(57) ABSTRACT

A safety seat for land vehicles, aircraft and watercraft, including a seat portion, a backrest and side supports. A second backrest is disposed on the safety seat and is comprised of two backrest parts, the position of which relative to one another is adjustable to thereby achieve a varying spacing from the front edge of the seat portion. The backrest parts have a curved configuration to rest against a person seated on the seat, and outer side edges of the backrest parts are respectively attached to the side supports of the safety seat. An adjustment mechanism is provided for adjusting the position of the backrest parts.

The instant application should be granted the priority date of Feb. 7, 2007 the filing date of the corresponding German patent application 10 2007 006 013.2.

### BACKGROUND OF THE INVENTION

The present invention relates to a safety seat for land vehicles, aircraft, and watercraft, with a seat portion, a backrest and laterally disposed supports.

A safety seat having the aforementioned features is known from DE 10 2004 062 350 B3. The safety seat is secured to a strap supporting structure provided in the vehicle, and has a seat portion and a backrest; laterally disposed supports can also be provided. Such a configuration of a safety seat is basically described in DE 43 03 719 A1.

If such safety seats are installed in armored vehicles, there is also the requirement that a so-called operator should sit on such a safety seat. The tasks of such an operator can vary greatly, and span the operation of normal control elements to extensive operations on computers, their keyboards and monitors. For this purpose, a seating arrangement is required for the respective operator that is to be seated on the safety seat, and which enables the best possible working position as a function of body size, clothing and the equipment carried by a person. In order to accommodate these requirements, seats have been used that have an adjustable seating position, yet are heavy and bulky. Therefore, such seats cannot be supported on a strap supporting structure disposed in the vehicle in order to be able to satisfy the additional requirement of protection against vibrations, impacts or blasts, for example due to mines.

It is therefore an object of the present invention to configure a safety seat having the aforementioned general features in such a way that, while also providing for possible support of the seat on a strap supporting structure, different seating positions are provided for the personnel that are to sit on the seat.

### BRIEF DESCRIPTION OF THE DRAWINGS

This object, and other objects and advantages of the present invention, will appear more clearly from the following specification in conjunction with the accompanying schematic drawings, in which:

FIG. 1 is a front perspective view of a safety seat having an adjustable backrest;

FIG. 2 is a rear view of the safety seat of FIG. 1; and

FIG. 3 shows a modified embodiment of the safety seat of FIG. 1.

### SUMMARY OF THE INVENTION

The basic concept of the present application is that a second backrest is disposed on the safety seat, wherein the second backrest is composed of two backrest parts, the position of which relative to one another is adjustable to thereby achieve a varying spacing from the front edge of the seat portion, whereby the backrest parts have a curved configuration to rest against the person seated on the seat, with the outer side edges of the backrest parts being respectively attached to the side supports of the safety seat, and wherein an adjustment mechanism is provided for the adjustment of the position of the backrest parts.

The present invention has the advantage that by means of the arrangement of a second backrest on the safety seat, which second backrest is adjustable due to its configuration from two backrest parts, there now exists the possibility of defining a varyingly sized seating surface on the seat portion, and at the same time, in the various seating positions, providing for an appropriate back support. If a larger person requires a larger seating surface, the backrest parts are loosened or released by means of the adjustment mechanism, and can be moved into a position in which the backrest parts release the required seating surface, but yet are disposed against the body of the person and support the person laterally as well as in the back region due to their curvature. The inventive backrest parts can be easily integrated into a safety seat of the aforementioned general type without significantly increasing the weight or the dimensions of the seat, so that safety seats that are configured in accordance with the present invention can also be supported or suspended on a vehicle-mounted strap supporting structure.

Pursuant to a first embodiment of the invention, the backrest parts can be interconnected by means of an accordion like portion that is disposed between them and is composed of a flexible material. As a result, the spacing or distance between the backrest parts relative to one another, which changes upon opening or closing of the backrest parts, is compensated for by the accordion like portion that is disposed between the backrest parts. When the distance between the two backrest parts is shortened, the accordion like portion is gathered or reduced and disappears behind one of the backrest parts in order not to disrupt the contact of the two backrest parts against the body of the occupant. When the distance or spacing increases for a larger person, the accordion like portion is extended and, together with the backrest parts, forms the required expansion of the second backrest.

Pursuant to another embodiment of the invention, one of the backrest parts can be fixed and, in the direction of its curvature, can have a dimension that is less than that of the movable backrest part, so that when the accordion like portion is gathered or tightened it can come to rest behind the fixed backrest part. Furthermore, the fixed backrest part, due to its shorter dimension, assumes only a lateral support, while the adjustment of the second backrest on the safety seat is essentially provided by the movable backrest part and the accordion like portion.

With regard to the adjustment of the two backrest parts, pursuant to another embodiment of the invention one of the two backrest parts is securely fixed to the safety seat, and the adjustment mechanism for the other, movable backrest part is disposed on the fixed backrest part. In this connection, in detail, the adjustment mechanism can be comprised of a cable that is attached to the fixed backrest part and that via one end thereof is attached to the movable backrest part while the other end is guided outwardly beyond the fixed backrest part and beyond the side support of the safety seat and can be secured to a retention device in the region of the front edge of the seat portion.

Pursuant to an alternative embodiment, both of the backrest parts can be movable relative to the safety seat and can be disposed such that they overlap one another, wherein a cable, as an adjustment mechanism, can be attached to each backrest part; each cable is guided outwardly beyond the side supports of the safety seat and can be secured to a retention device in the region of the front edge of the seat portion.

With regard to the configuration of the retention device for the various lengths of the cable that are to be respectively established in conformity with the different positions of the backrest parts relative to one another, pursuant to embodiments of the invention the retention device can be comprised of a clamping mechanism for the cable, or the retention device can be comprised of spaced-apart attachment mechanisms that are mounted on the seat portion or the end of the cable.

Pursuant to another embodiment of the invention, the safety seat in the vehicle can be secured to a vehicle-mounted strap supporting structure that is provided with at least two supports straps; such a securement is basically disclosed in the aforementioned DE 10 2004 062 350 B3.

Further specific features of the present application will be described in detail subsequently.

### DESCRIPTION OF SPECIFIC EMBODIMENTS

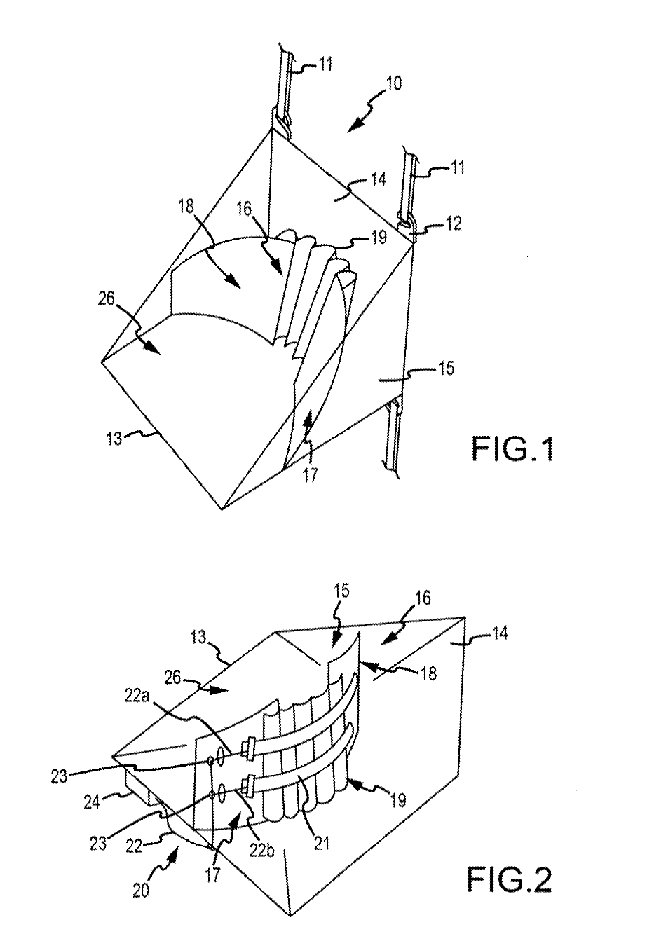

Referring now to the drawings in detail, the safety seat 10, as shown in FIG. 1, is secured via attachment or suspension means 12 to support straps 11 that are attached to the vehicle, as is illustrated only schematically in the present application. By means of these attachment means 12, the safety seat 10 can be supported on the support straps 11 at various height positions. Other details of such a vehicle-mounted strap supporting structure can be ascertained from the aforementioned DE 10 2004 062 350 B3. The safety seat 10 is comprised of a seat portion 13, a backrest 14 provided between the support straps 11, and side supports 15, which for example similar to the backrest can be comprised of a complete piece of material or also of diagonal straps that extend diagonally between the support straps 11 or the backrest 14 and the front edge of the seat portion 13.

For the adjustment of different sitting positions of a person sitting on the seat portion 13, accompanied by a fixation of different dimensions of the seating surface 26, a second backrest 16 is formed on the safety seat 10. With the embodiment illustrated in FIGS. 1 and 2, the second backrest 16 is comprised of two backrest parts 17 and 18, whereby the backrest part 17 is fixed on the safety seat 10, while the backrest part 18 is movable. For this purpose, the outer side edges of the two backrest parts 17 and 18 can be connected with the pertaining side supports 15, whereby with regard to the fixation of the backrest part 17, a connection of the backrest part 17 with the seat portion 13 can be provided. The two backrest parts 17, 18 are interconnected by an accordion like portion 19 that is comprised of a preferably textile, flexible material. At different positions of the backrest parts 17 and 18 relative to one another, the accordion like portion 19 interconnects the two backrest parts 17, 18 in various reduced or tightened states, and to this extent provides a back support for the person seated on the seat portion 13. In an expedient manner, the fixed backrest part 17 is provided with a dimension that in the direction of its curvature is less than that of the movable backrest part 18. On the one hand, such a lesser dimension is adequate for the fixation of the still to be described adjustment or control mechanism 20, as well as for accommodating the accordion like portion 19 that is pushed together during the tightening or reduction, and that with the forward position of the movable backrest part 18 comes to rest behind the fixed backrest part 17. Furthermore, due to its shorter dimension, the fixed backrest part 17 essentially provides for the side support of the person seated upon the safety seat 10, whereas the back support that is adaptable in its position is provided by the accordion like portion 19 and the movable backrest part 18. Although the illustrated embodiment has been described with the backrest part 17 fixed and the backrest part 18 movable, it is to be understood that the backrest part 18 could be fixed with the backrest part 17 being movable.

An adjustment or control mechanism 20 is provided for the adjustment of the position of the backrest parts 17, 18; the adjustment mechanism 20 is comprised of a cable 22 that is divided into two cable sections 22a, 22b which are guided over guide means 23 mounted on the fixed backrest part 17 and extend over the accordion like portion 19 up to the movable backrest part 18, to which they are attached. To protect the accordion like portion 19, the two cable sections 22a, 22b are guided in a collection band 21 that spans the accordion like portion 19. To fix the cable 22 in position, it is secured in a retention device 24 that is disposed in the forward region of the seat portion 13.

Upon use of the safety seat 10, the retention device 24 is loosened, so that the movable backrest part 18 can be brought into various positions relative to the fixed backrest part 17. To the extent that in connection therewith the spacing between the fixed backrest part 17 and movable backrest part 18 is altered, this spacing or distance is bridged by the accordion like portion 19, which assumes different gathered or reduced states. The cable 22 is subsequently fixed in position in the retention device 24.

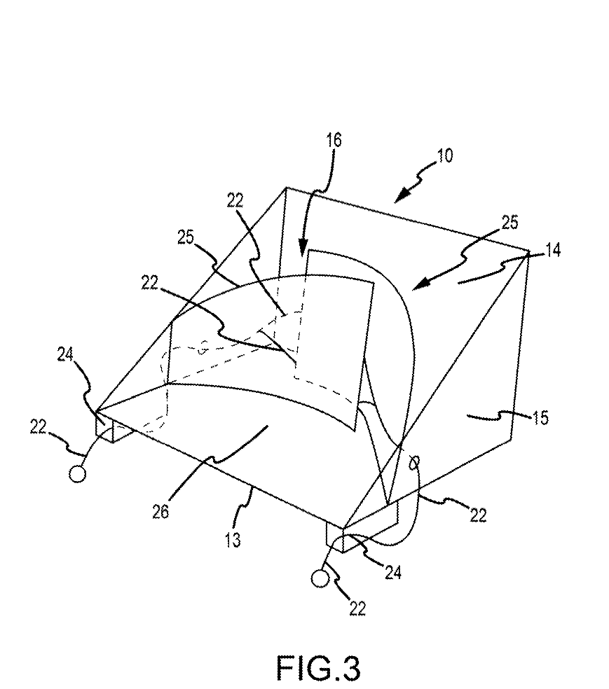

In the alternative embodiment illustrated in FIG. 3, the two backrest parts 25 of the additional or second backrest 16 are both movable relative to the safety seat 10 and are embodied in such a way that in all positions of the backrest 16 they overlap one another. A cable 22 is attached to each of the two backrest parts 25; each cable 22 is guided to retention devices 24 mounted on the seat portion 13 on both sides of the seating surface 26, so that by actuating the cables 22, the two movable backrest parts 25 can be brought into the desired position.

The features of the subject matter of the present application disclosed in the specification, the claims, the abstract and the drawings can be important individually as well as in any desired combination with one another for realizing the various embodiments of the invention.

The specification incorporates by reference the disclosure of German priority document 10 2004 006 013.2 filed Feb. 7, 2007.

The present invention is, of course, in no way restricted to the specific disclosure of the specification and drawings, but also encompasses any modifications within the scope of the appended claims.

What I claim is:

1. A safety seat for land vehicles, aircraft, and watercraft, wherein said safety seat includes a seat portion (13), a first backrest (14), and side supports (15), and wherein said safety seat further comprises:
a second backrest (16) composed of two backrest parts (17, 18; 25), wherein said backrest parts have a curved configuration and outer side edges respectively attached to ones of said side supports (15), and wherein said backrest parts (17, 18; 25) are adjustable in position relative to one another to thereby achieve a varying spacing of said second backrest (16) from a front edge of said seat portion (13); and
an adjustment mechanism (20) for effecting adjustment of a position of said backrest parts (17, 18; 25) relative to one another.

2. A safety seat according to claim 1, wherein an accordion like portion (19) comprised of flexible material is disposed between said backrest parts (17, 18), and wherein said backrest parts are interconnected via said accordion like portion (19).

3. A safety seat according to claim 1, wherein one of said backrest parts (17) is fixedly disposed on said safety seat, further wherein the other of said backrest parts (18) is movably disposed on said safety seat, and wherein said adjustment mechanism (20) is disposed on said fixed backrest part (17) and is adapted to effect adjustment of a position of said movable backrest part (18).

4. A safety seat according to claim 3, wherein said fixed backrest part (17), in the direction of its curved configuration, has a dimension that is less than a comparable dimension of said movable backrest part (18).

5. A safety seat according to claim 3, wherein said adjustment mechanism (20) is comprised of a cable (22) that is attached to said fixed backrest part (17), wherein a first end of said cable (22) is attached to said movable backrest part (18), wherein a second end of said cable (22) is guided outwardly beyond said fixed backrest part (17) and beyond said side supports (15) of said safety seat, wherein a retention device (24) is disposed on said safety seat in a region of a front edge of said seat portion (13), and wherein said second end of said cable (22) is adapted to be secured to said retention device (24).

6. A safety seat according to claim 1, wherein said two backrest parts (25) are movably disposed on said safety seat so as to overlap one another, wherein said adjustment mechanism (20) is comprised of a respective cable (22) attached to each of said backrest parts (25), wherein retention devices (24) are disposed on said safety seat in a region of a front edge of said seat portion (13), and wherein each of said cables (22) is guided outwardly beyond one of said side supports (15) of said safety seat and is adapted to be secured to a respective one of said retention devices (24).

7. A safety seat according to claim 5, wherein said retention device (24) is comprised of a clamping mechanism for said cable (22).

8. A safety seat according to claim 6, wherein each of said retention devices (24) is comprised of a clamping mechanism for one of said cables (22).

9. A safety seat according to claim 5, wherein said retention device is comprised of a plurality of spaced apart attachment means disposed on said seat portion (13) for an end of said cable (22).

10. A safety seat according to claim 6, wherein each of said retention devices is comprised of a plurality of spaced-apart attachment means disposed on said seat portion (13) for an end of one of said cables (22).

11. A safety seat according to claim 1, wherein said safety seat is secured to a vehicle-mounted strap supporting structure that is provided with at least two support straps.
